(19) United States
(12) Patent Application Publication
(10) Pub. No.: US 2005/0017597 A1
(43) Pub. Date: Jan. 27, 2005

(54) End ring support structure for electric motor

(76) Inventor: Harold H. Mays, Denver, CO (US)

Correspondence Address: CARLSON, GASKEY & OLDS, P.C., 400 WEST MAPLE ROAD, SUITE 350, BIRMINGHAM, MI, 48009, US

(21) Appl. No.: 10/625,304

(22) Filed: Jul. 23, 2003

(51) Int. Cl. H02K 5/24; H02K 5/00

(52) U.S. Cl. 310/271; 310/211; 310/51

(57) ABSTRACT

A support sleeve press-fitted onto an end ring of a rotor applies a compressive pre-load stress on the end ring to counteract centrifugal stresses generated during rotor operation. In one embodiment, the support sleeve is made of a high-strength material having a thermal growth coefficient that is substantially the same as the thermal growth coefficient of the end ring material to minimize centrifugal and thermal stress in the end ring.

### TECHNICAL FIELD

The present invention is directed to a rotor structure for an electric motor, and more particularly to a rotor having end rings.

### BACKGROUND OF THE INVENTION

Electric motors, such as induction motors, are commonly used in many different applications. Generally, electric motors include a rotor that rotates in a magnetic field. The rotor includes a rotor core that is often formed from a plurality of laminations. As the rotational velocity of the rotor increases, centrifugal stress on the rotor also increases. This centrifugal stress may adversely affect the structure of the rotor (e.g., loosen the laminations forming the rotor core), particularly at the ends.

Some rotor structures have end rings attached to the ends of the rotor to pre-stress the laminations and prevent them from loosening. The end rings themselves, however, may experience excessive centrifugal stress, particularly at high rotor speeds. Centrifugal stress in the end rings can undesirably limit the output power of the rotor, particularly if they are made of low-strength materials chosen solely for their conductive properties (e.g., cast aluminum). Further, if the rotor is operated in a higher temperature environment, thermal stress in the end rings may further limit the output power. Also, the stress in the end rings can limit the maximum speed at which the rotor can rotate.

There is a desire for a rotor end ring structure that is less susceptible to centrifugal stresses, thereby preserving the maximum possible output power of the rotor.

There is also a desire for a rotor end ring structure that can maximize the operating speed of the motor for a given material strength in the end ring.

### SUMMARY OF THE INVENTION

The present invention is directed to an apparatus that applies a compressive pre-load stress on the end ring to compensate for stresses in the end ring during motor operation. In one embodiment, a support sleeve is attached to the end ring via an interference fit. The compressive pre-load stresses counteract centrifugal stresses in the end ring while the rotor rotates.

In one embodiment, the support sleeve is made of a high-strength material having a thermal growth coefficient that is substantially the same as the thermal growth coefficient of the end ring material. This ensures that the end ring and support sleeve will expand and contract at the same rate to minimize thermal stress in the end ring.

By minimizing centrifugal and thermal stresses in the end ring, the inventive structure improves the output power of the rotor for a given speed and also increases the operating speed for an end ring having a given material strength.

### BRIEF DESCRIPTION OF THE DRAWINGS

FIG. 1 is a representative diagram of a rotor according to one embodiment of the invention;

FIG. 2 is a close-up view of a portion of the rotor core shown in FIG. 1; and

FIG. 3 is a graph illustrating one example of stresses for a rotor structure according to one embodiment of the invention.

### DETAILED DESCRIPTION OF THE EMBODIMENTS

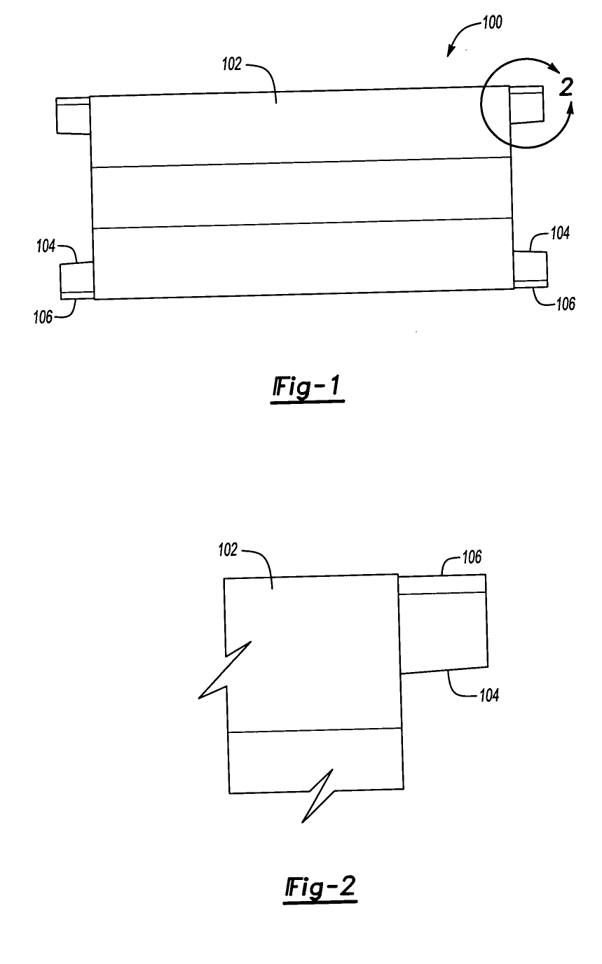

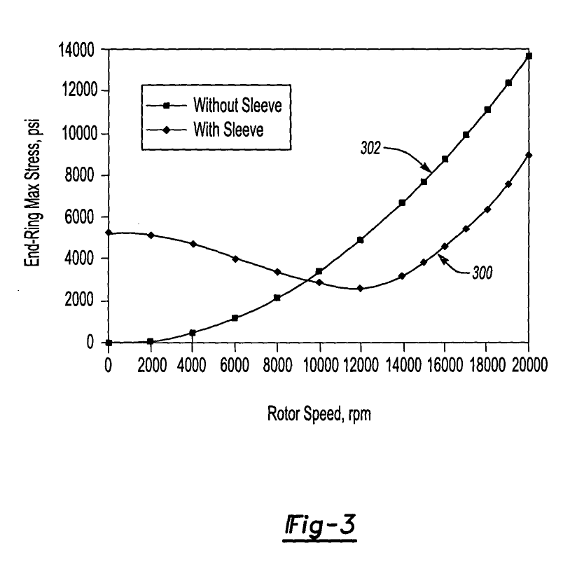

FIGS. 1 and 2 are representative diagrams of a rotor 100 having an end ring structure according to one embodiment of the invention. The rotor 100 has a rotor core 102 with an end ring 104 disposed on each end of the rotor core 102. As is known in the art, the rotor 100 is designed to rotate in a magnetic field generated by an electromagnet (not shown).

For a rotor having a given length L and diameter N, the power P that can be output by the rotor 100 equals P=f(D²LN), where f is the amount of stress on the end rings 104 and N is the rotational speed of the end rings 104. As can be seen in the equation, the power output of the rotor 100 may be limited by the amount of stress f that the end rings 104 can handle.

End rings are often made of cast aluminum, which has high electrical conductivity but relatively low strength. Although the electrical properties of the cast aluminum end rings are desirable, the low strength of the aluminum makes the end rings 104 susceptible to centrifugal stresses caused by the rotor 100 rotation. To improve the stress characteristics of the end rings 104, the inventive structure includes a support sleeve 106 that fits around each end ring 104. The support sleeve 106 reinforces the end ring 104 and shields the end ring 104 from excess centrifugal stress. The support sleeve 106 is preferably attached to the end ring 104 via an interference fit or similar force fit around the circumference of the end ring 104.

Optimally, the end-ring is prestressed to the maximum allowable limit determined by the yield strength of the material. On the other hand, the support sleeve is designed to be at its yield strength when the static load and the centrifugal load at the maximum operating speed are combined. The radial thickness of the support sleeve and the magnitude of the interference fit are chosen to optimize the distribution of stress between the end-ring and support sleeve. In one embodiment, the magnitude of the interference fit is between 0.27% and 0.33% of the nominal diameter of the interface between the inner diameter of the support sleeve 106 and the outer diameter of the end ring 104. Greater interference fit magnitudes are possible, but the amount of compressive stress applied by the support sleeve 106 preferably should not exceed the yield strength of the support sleeve 106 material.

The interference fit between the support sleeve 106 and the end ring 104 causes a compressive pre-load stress in the end ring 104 material. The rotor 100 is preferably static when the support sleeve 106 is attached to the end ring 104. When the rotor 100 is rotated during motor operation, the compressive pre-load stress helps counteract tensile stress in the end ring 104 due to centrifugal forces.

The support sleeve 106 can be made of any material having material characteristics appropriate for the particular environment in which the rotor 100 will operate. Possible support sleeve 106 materials include aluminum, aluminum alloy, copper, copper alloy, nickel, nickel alloy, titanium, and steel, or other similar materials. Note that motors using steel and other ferromagnetic materials in the support sleeve 106 may experience power loss and heat generation due to the magnetic field in which the rotor 100 rotates, but these potential disadvantages may not be a concern for certain applications. The optimum material and geometry for the support sleeve 106 can be selected based on, for example, the rotor 100 size, the specific application in which the rotor 100 will operate, the expected rotor operating speed range, and other motor operational parameters. In one embodiment, the geometry and material in the support sleeve 106 are chosen to maintain the interference fit even when the rotor 100 is rotating at its maximum speed.

Regardless of the material selected for the support sleeve 106, the material should have high strength and sufficient ductility to accommodate any physical changes in the end rings 104. High-strength materials in the support sleeve 106 also minimize growth in the sleeve due to centrifugal forces and power losses due to eddy currents. Further, if the end rings 104 will experience elevated temperatures, the support sleeve 106 should be made of a thermally-conductive material. Non-magnetic materials are preferred to minimize power loss and heat generation, but ferromagnetic materials may also be used for the sleeve 106. In one embodiment, the support sleeve 106 is made of a material that has generally the same thermal growth coefficient as the material used in the end ring 104. This ensures that the end ring 104 and the support sleeve 106 expand and contract at the same rate, preserving the interference fit between the two components and minimizing thermal stress.

FIG. 3 illustrates an example comparing the stress characteristic 300 of an end ring 104 supported by the support sleeve 106 and the stress characteristic 302 of an end ring without the sleeve 106. While the rotor 100 is rotating at speeds below 7500 rpm, the stress in the supported end ring is greater than the stress in a bare end ring because the sleeve 106 is applying compressive pre-load stress onto the end ring 104. As the rotor speed increases, the stress in the bare end ring increases steadily. The stress in the supported end ring, by contrast, actually decreases as the motor speed increases because the compressive pre-load stress in the supported end ring is being counteracted by the centrifugal stress caused by motor operation. In this example, the stress in the end ring 104 is minimized at around 12400 rpm.

As the rotor speed increases further, the stresses in both the supported and bare end rings will increases, but the supported end ring will still have lower stresses than the bare end ring for a given speed. The support sleeve can therefore increase the maximum operating speed for an end ring having a given material strength because the support sleeve counteracts at least some of the centrifugal stresses on the end ring.

The optimum sleeve geometry and material depends in part on whether the rotor 100 application calls for minimized stress in the end rings 104 or maximum operating speed. Determining the optimum sleeve 106 geometry and material for a given rotor 100 based on the above description is within the capabilities of one of ordinary skill in the art.

It should be understood that various alternatives to the embodiments of the invention described herein may be employed in practicing the invention. It is intended that the following claims define the scope of the invention and that the method and apparatus within the scope of these claims and their equivalents be covered thereby.

1. A rotor for an electric motor, comprising:
a rotor core;
at least one end ring connected to the rotor core; and
at least one support sleeve attached to said at least one end ring via an interference fit, wherein the support sleeve applies a compressive stress on the end ring,
wherein the support sleeve and the end ring material are made from the same material, and wherein the support sleeve is alloyed to have a higher mechanical strength than the end ring.

2. The rotor of claim 1, wherein the support sleeve is made from a support sleeve material having a thermal characteristic that is the same as a thermal characteristic of an end ring material.

3. (Cancelled)

4. (Cancelled)

5. (Cancelled)

6. The rotor of claim 1, wherein a magnitude of the interference fit is between 0.1% and 0.5% of a nominal diameter of an interface between the end ring and the support sleeve.

7. The rotor of claim 1, wherein the support sleeve is made from one of the group consisting of aluminum, aluminum alloy, copper, copper alloy, nickel, nickel allow, titanium, and steel.

8. The rotor of claim 1, wherein an assembly stress applied to the end ring is less than a tensile yield strength of the support sleeve and the compressive strength of the end ring.

9. An electric motor, comprising:
an electromagnet that generates a magnetic field;
a rotor that rotates in the magnetic field, the rotor comprising
a rotor core having a first end and a second end,
first and second end rings connected to said first and second ends, respectively, of the rotor core, and
first and second support sleeves interference-fitted onto said first and second end rings, respectively, to apply a compressive stress on the first and second end rings,
wherein the support sleeve and the end ring are made from the same material and have the same thermal characteristic, wherein the support sleeve has at least the same mechanical strength than the end ring, and wherein the support sleeve is allowed to have a higher mechanical strength than the end ring.

10. (Cancelled)

11. The electric motor of claim 9, wherein a magnitude of the interference fit is between 0.1% and 0.5% of a nominal diameter of an interface between the end ring and the support sleeve.

12. The electric motor of claim 9, wherein the support sleeve is made from one of the group consisting of aluminum, aluminum alloy, copper, copper alloy, nickel, nickel allow, titanium, and steel.

13. The electric motor of claim 9, wherein an assembly stress applied to the end ring is less than a tensile yield strength of the support sleeve and the compressive strength of the end ring.
